(19) United States
(12) Patent Application Publication
(10) Pub. No.: US 2014/0332291 A1
(43) Pub. Date: Nov. 13, 2014

(54) TROLLEY FOR THE TRANSPORTATION OF A LOAD ON STAIRCASES

(71) Applicants: CLAUDIO ZONZINI, Casaleone (VR) (IT); Jacopo ZONZINI, Casaleone (VR) (IT); Arianna ZONZINI, Casaleone (VR) (IT)

(72) Inventors: CLAUDIO ZONZINI, Casaleone (VR) (IT); Jacopo ZONZINI, Casaleone (VR) (IT); Arianna ZONZINI, Casaleone (VR) (IT)

(21) Appl. No.: 14/273,246

(22) Filed: May 8, 2014

(30) Foreign Application Priority Data
May 9, 2013 (IT) VR2013A000107

(51) Int. Cl. B62D 55/075; B62B 5/02; B62B 3/02; B62D 55/04; B62B 5/00

(52) U.S. Cl. CPC B62D 55/075; B62D 55/04; B62B 5/0026; B62B 3/02; B62B 5/02
USPC 180/9.28; 180/9.42

(57) ABSTRACT

The present invention is a trolley that can safely transport a load on staircases, so as to prevent ruining or overturning the load. The trolley can easily ascend onto the first step and easily descend from the last step of a staircase. The trolley provides adjustable transport conditions during the ascent and descent on and from a staircase. The trolley can transport a load on straight staircases and on helical staircases, even with very low curvature radius. The trolley can be driven starting from both sides. The trolley can balance the load during the transportation on staircases.

The present invention regards a trolley for transporting a load on staircases, both straight and helical staircases.

Trolleys have already been proposed for transporting loads on staircases, which usually have a frame mounted on wheels or tracks and a grip handle.

Nevertheless, up to now a trolley has not been proposed that allows easily transporting any type of load on a wide range of staircases.

The main object of the present invention is to provide a new trolley that is suitable for transporting a load on staircases.

Another object of the present invention is to provide a new trolley that allows safely transporting a load on staircases, so as to prevent ruining or overturning the load.

Another object of the present invention is to provide a new trolley that can be made to easily ascend onto the first step or easily descend from the last step of a staircase.

Another object of the present invention is to provide a trolley by means of which the transport conditions can be easily adjusted during the ascent and descent on and from a staircase.

Another object of the present invention is to provide a trolley capable of transporting a load on straight staircases and on helical staircases, even with very low curvature radius.

Another object of the present invention is to provide a trolley that can be driven starting from both sides thereof.

Another object of the present invention is to provide a trolley capable of balancing the load during the transportation on staircases.

According to a first aspect of the present invention a trolley is provided for the transportation of a load on staircases having a main support frame, at least one main track rotatably mounted thereby projecting below the main support frame in order to define a first lower slide surface for the trolley, motor means or actuation means for the at least one main track, and at least one load bed supported by the main support frame,

the trolley comprising:
at least one auxiliary frame structure provided with support and slide or roll means delimiting a second slide surface on the lower part, and
lifting-lowering means for the at least one auxiliary frame structure intended to move the at least one auxiliary frame structure with respect to the main support frame between:
   an upper rest position, in which the at least one auxiliary frame structure is located with its support and slide or roll means at a higher level than that of the first slide surface and the trolley is movable by the at least one main track, and
   a lower work position, in which the main support frame is at a level higher than the at least one auxiliary frame structure and the trolley rests on the at least one auxiliary frame structure and is movable on the slide or roll means.

Advantageously, when the auxiliary frame structure is placed in the lower work position, the at least one main track projects beyond the auxiliary frame structure at the front and/or back of the trolley.

Preferably, the lifting-lowering means comprise at least one linear actuator pivoted at one end thereof to a portion of the auxiliary frame structure and at the other end thereof to the main support frame, and the lifting-lowering means can comprise an articulated polygon group pivoted on one side to the auxiliary frame structure and on the other side to the main support frame.

According to another aspect of the present invention a trolley is provided for the transportation of a load on staircases having a main support frame, at least one main track rotatably mounted so as to project below the main support frame in order to define a first lower slide surface for the trolley, actuation means for the at least one main track, and at least one load bed supported by the main support frame,

the trolley then comprising means for the angular movement of the at least one load bed with respect to the main support frame, and further:
at least one auxiliary track placed on the front or on the back of the at least one main track and tilted or tiltable with respect to the at least one main track, the at least one main track being mounted on first pulleys or toothed wheels rotatable on first rotation axes, whereas the at least one auxiliary track is sent around second pulleys or toothed wheels rotatably mounted on second rotation axes, the first rotation axes being substantially parallel or coinciding with the second rotation axes, or
at least one secondary section of the at least one main track tilted or tiltable with respect to a main section of the at least one main track, the at least one secondary section being placed at the front or back of the trolley.

Preferably, a trolley according to the present invention comprises at least one linear actuator designed to angularly move the at least one auxiliary track with respect to the at least one main track.

Advantageously, the support and slide or roll means comprise wheels that can be oriented in different running directions.

Preferably, a trolley according to the present invention comprises actuator means set to translate the at least one load bed onto the support frame.

Preferably, a trolley according to the present invention comprises a movable frame slidably mounted on the support frame and pivoted to the load bed, the actuator means that are set to translate comprising a linear actuator pivoted on one side to the support frame and on the other side to the movable frame.

A trolley according to the present invention can then include at least two main tracks substantially parallel to and spaced from each other, and each main track can be actuated by a respective motor means in a manner independent from the other main track.

Further aspects and advantages of the present invention will be clearer from the following detailed description of specific embodiments thereof, such description made with reference to the accompanying drawings, in which:

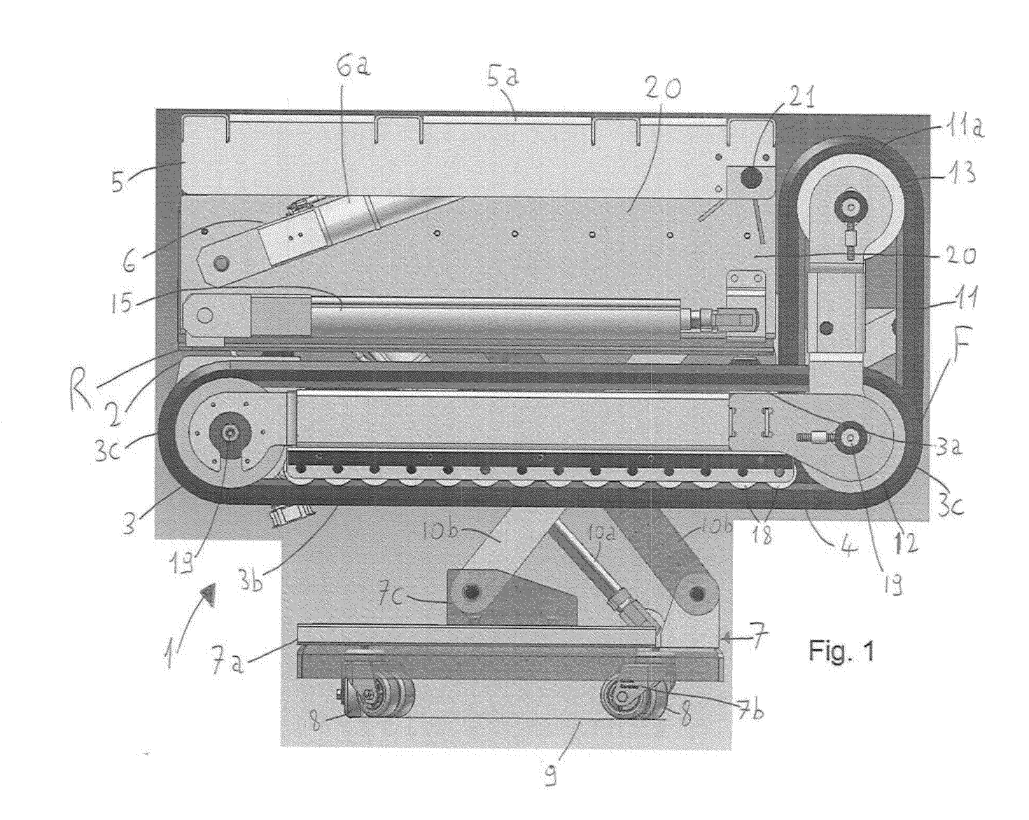

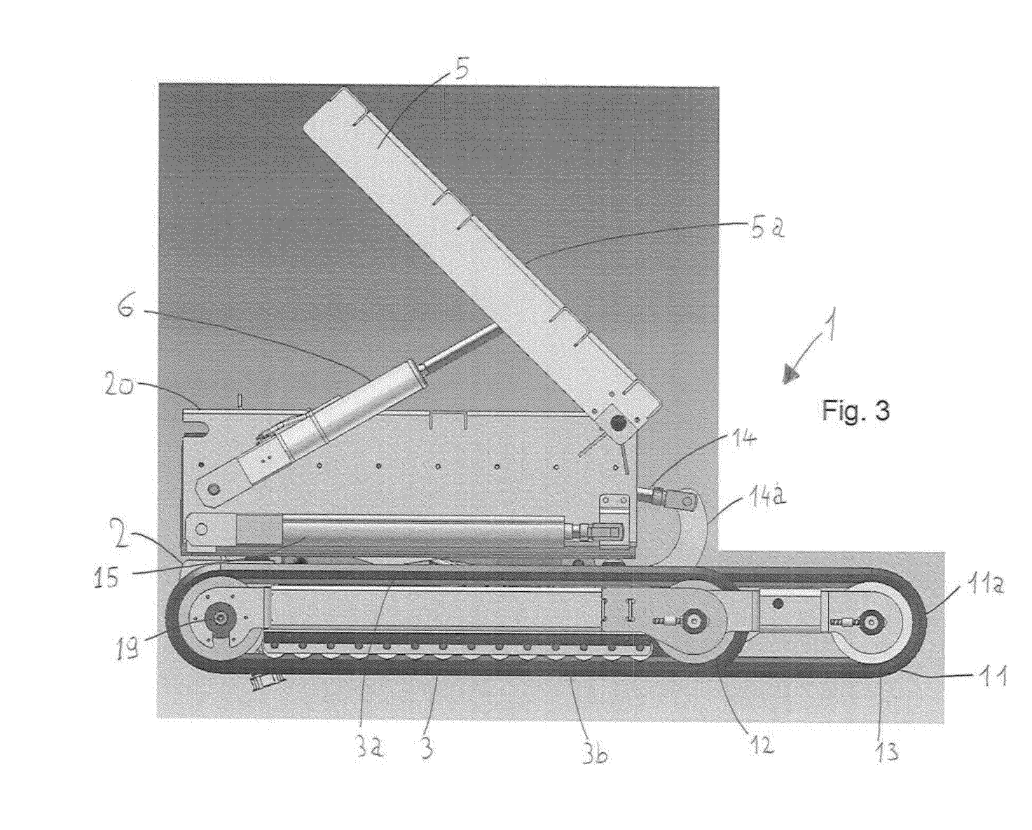

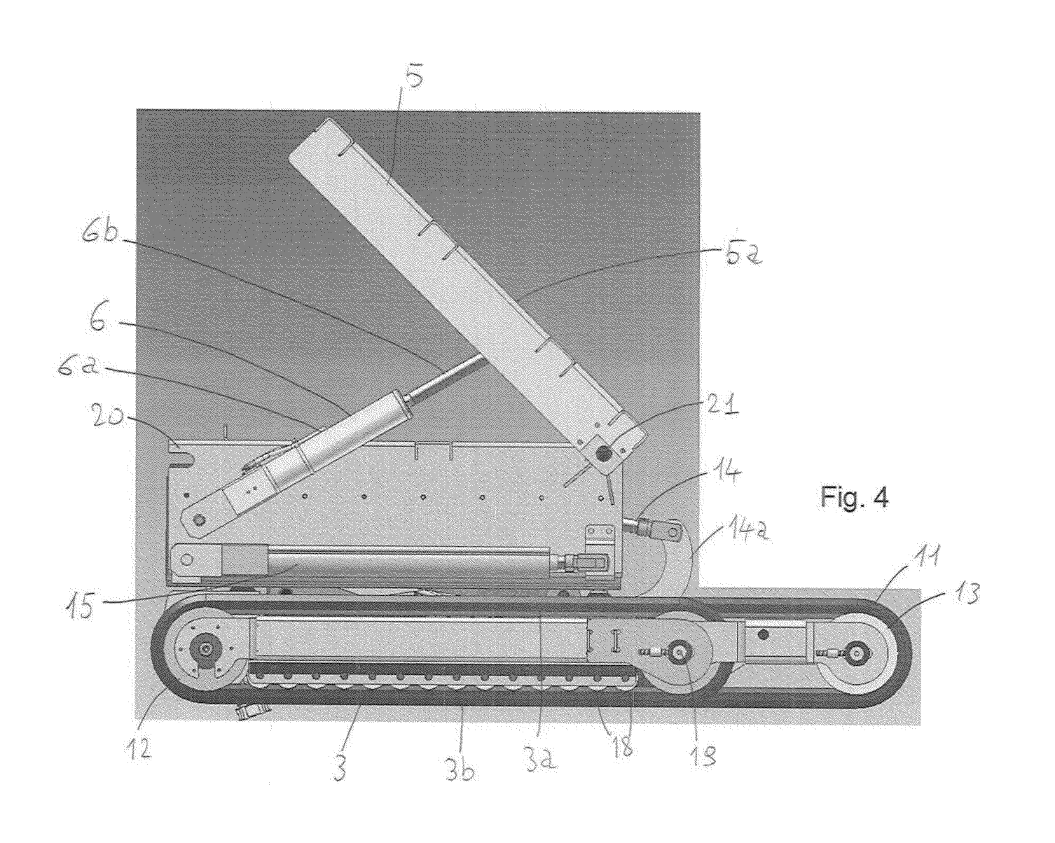

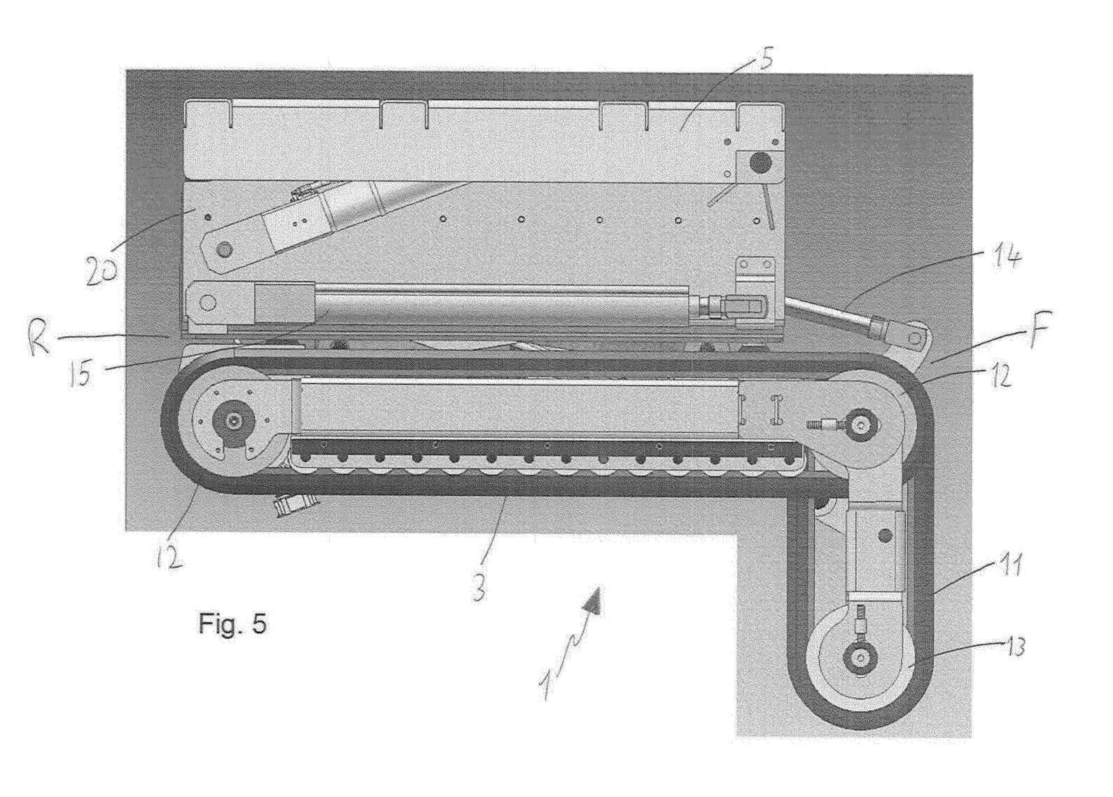

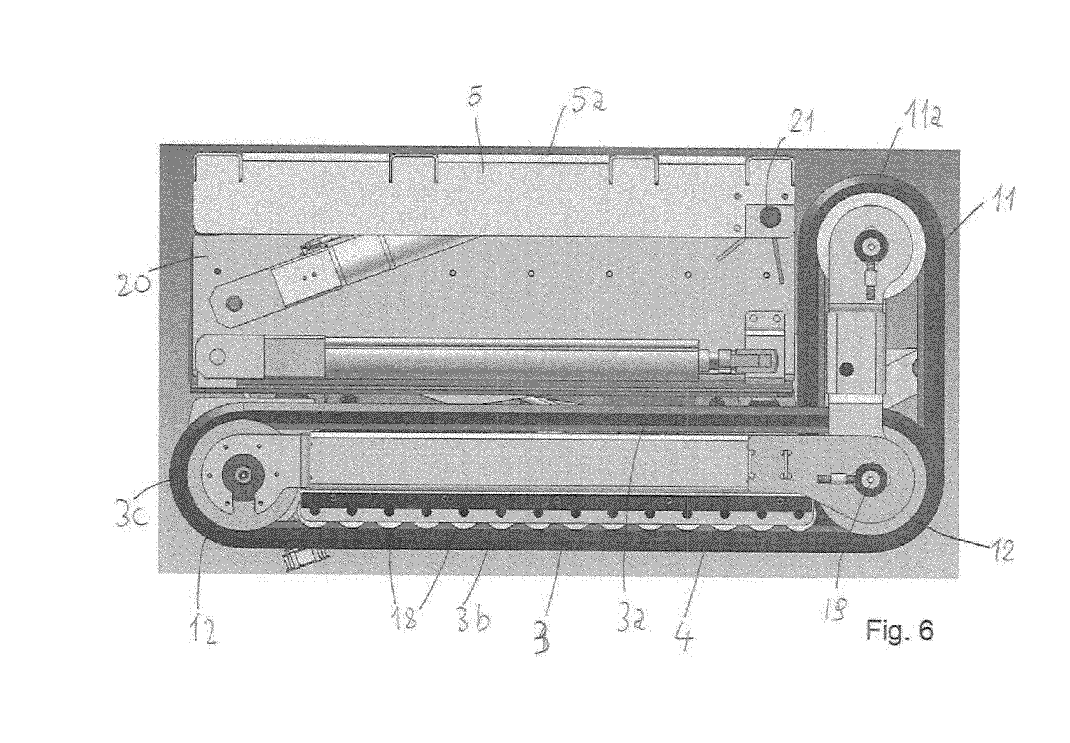

FIGS. 1 to 7 are longitudinal section views of a trolley embodiment according to the present invention in respective operative positions;

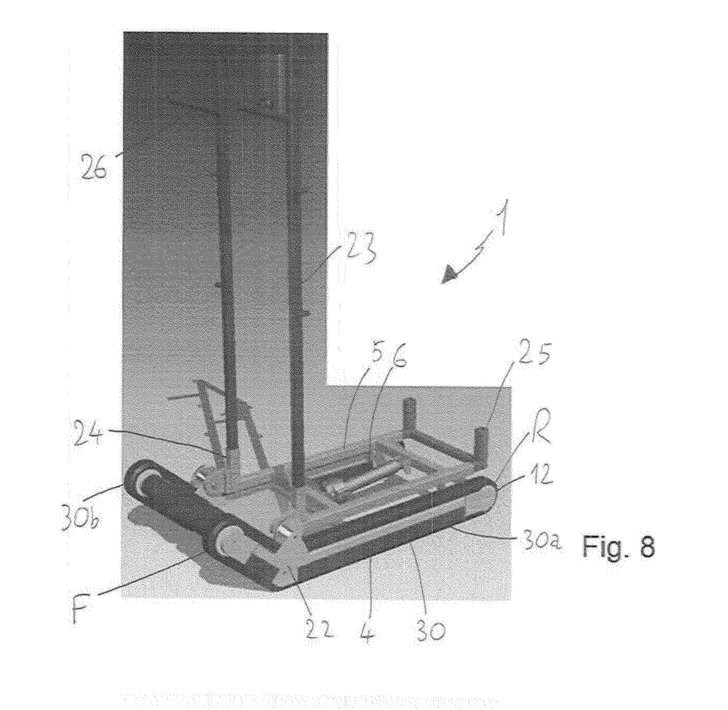

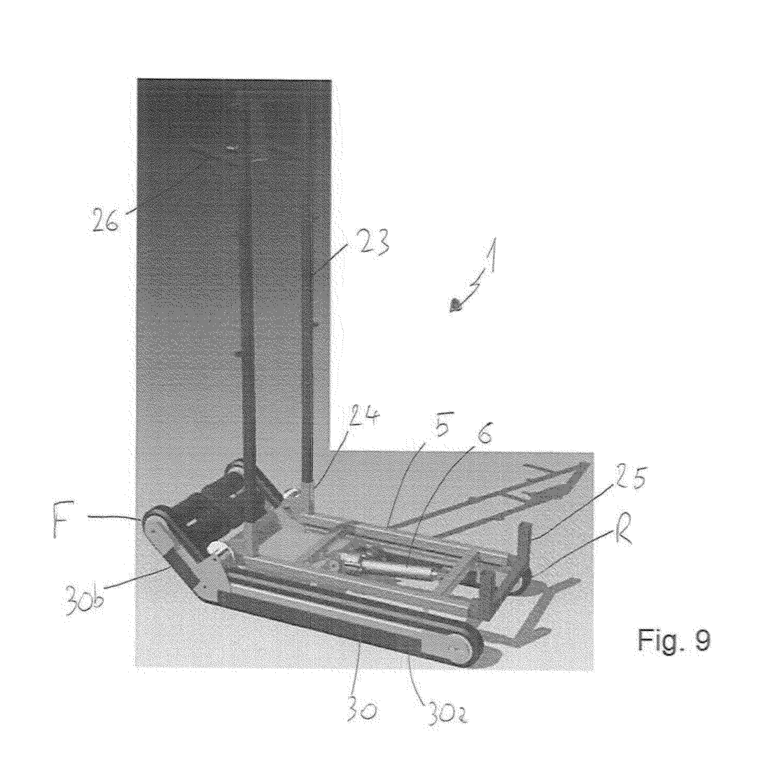

FIGS. 8 and 9 are slightly top perspective views of a second trolley embodiment according to the present invention with handle on the front of the trolley;

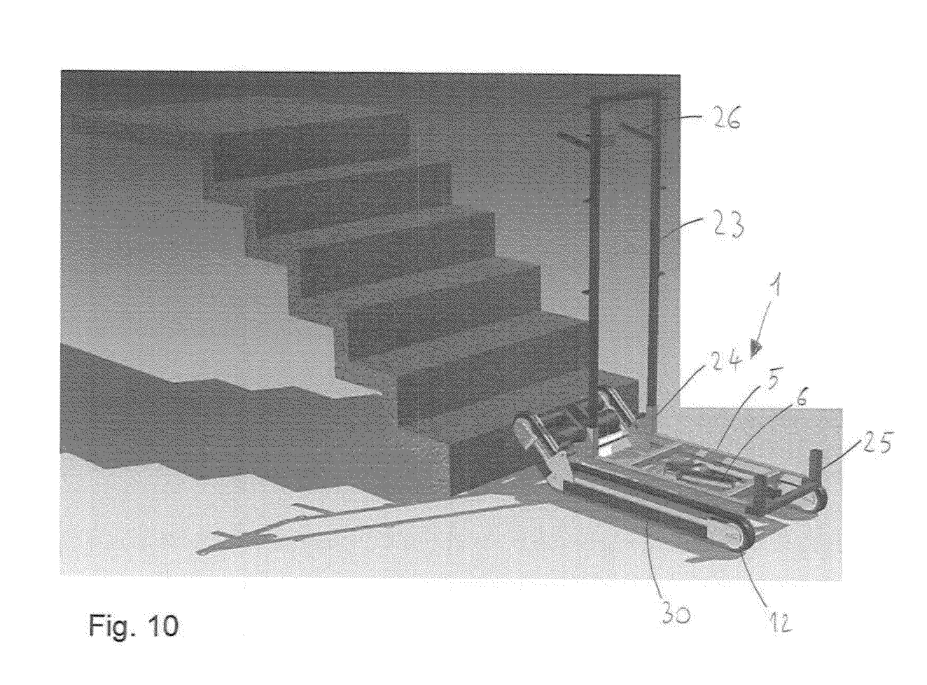

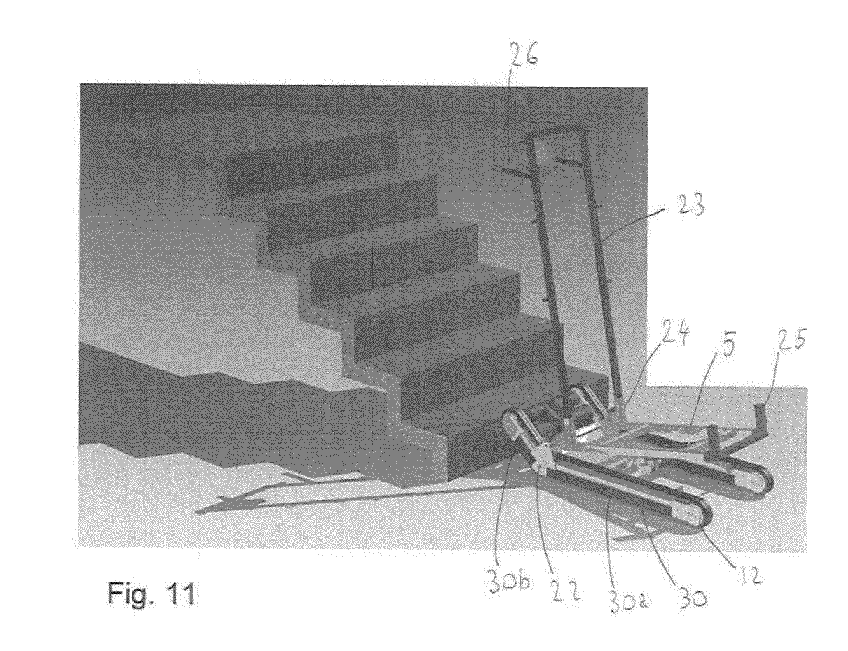

FIGS. 10 to 12 are slightly top perspective views of the trolley of FIGS. 8 and 9 during respective transportation steps of a load on a staircase;

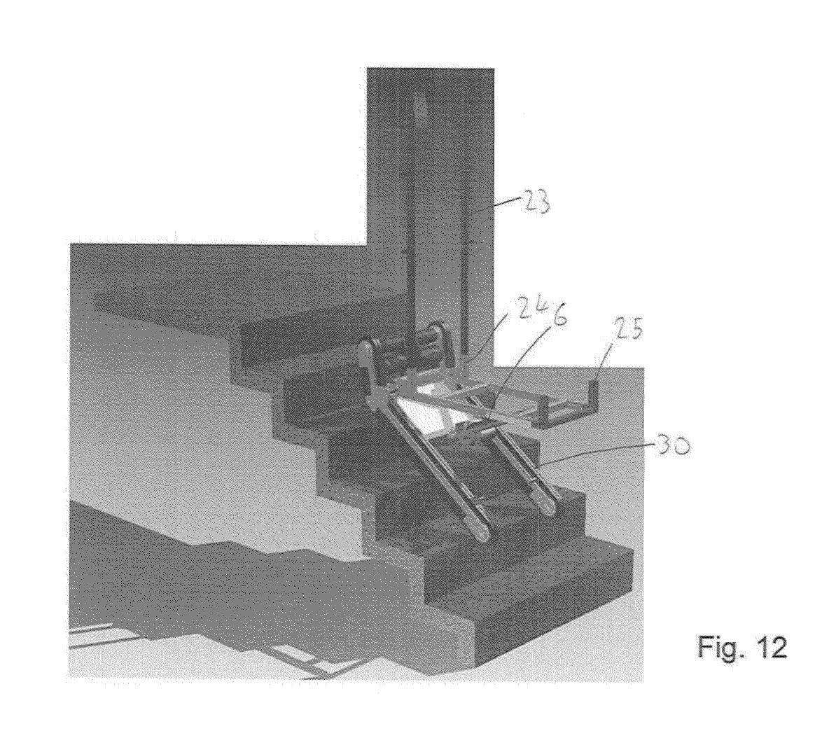

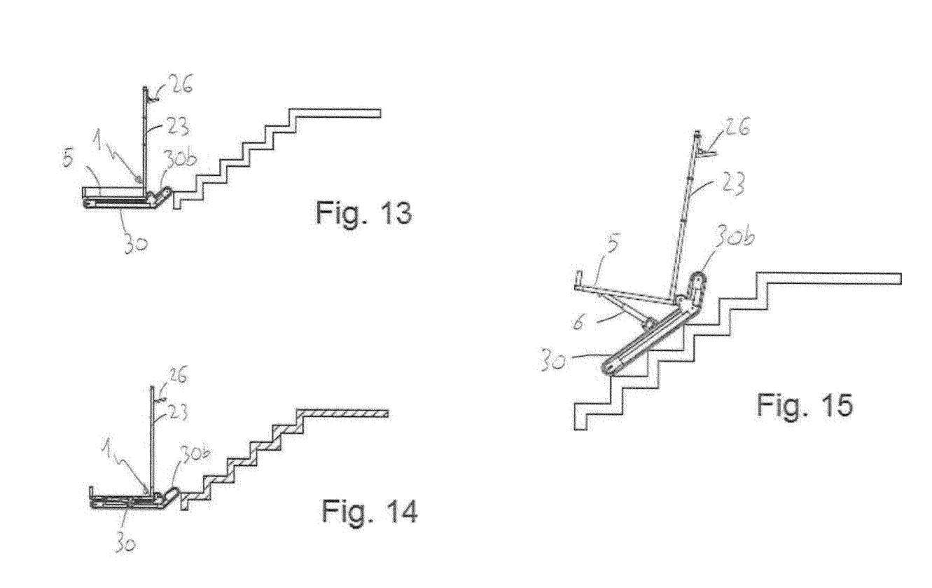

FIGS. 13 to 15 are side views of the trolley of FIGS. 8 and 9 during respective transportation steps for a load on a staircase;

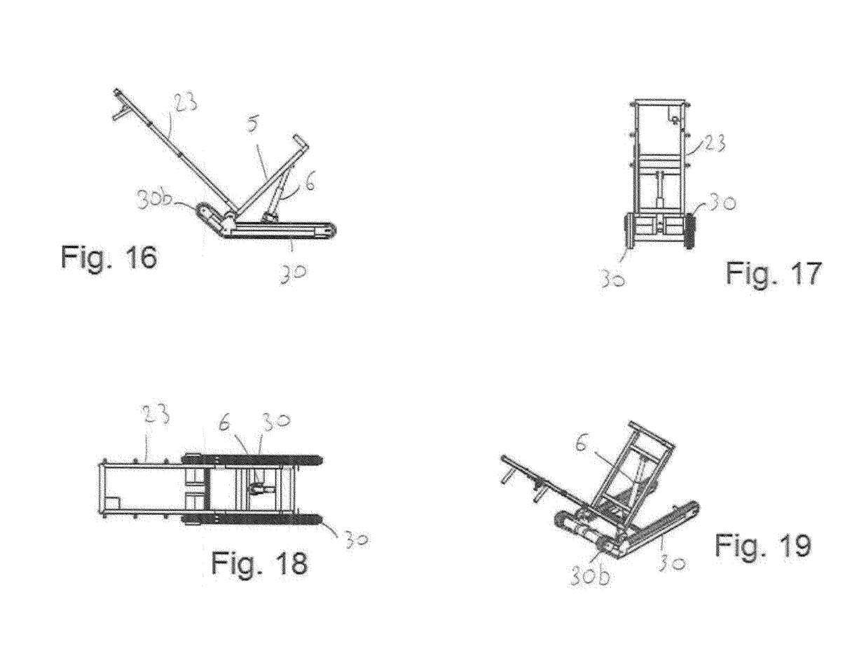

FIGS. 16 to 19 are respectively side, front, bottom and slightly top perspective views of the trolley of FIGS. 8 and 9;

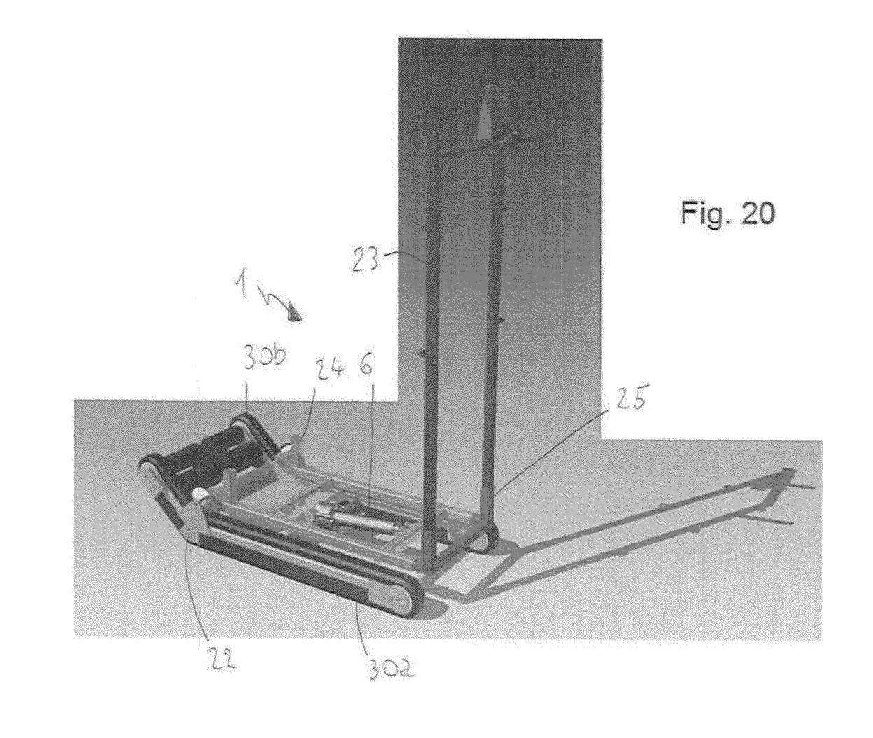

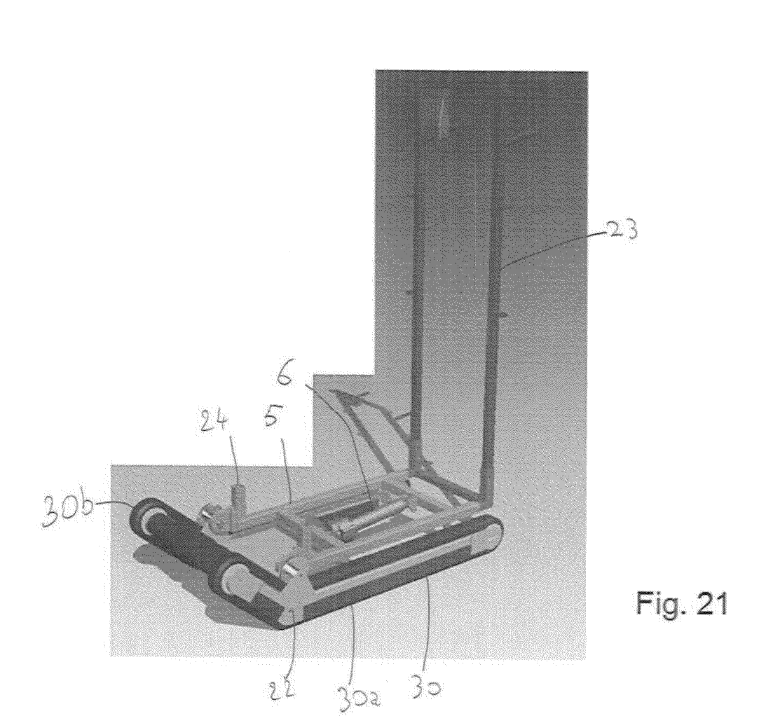

FIGS. 20 and 21 are slightly top perspective views of the trolley of FIGS. 8 and 9 according to the present invention with handle on the back;

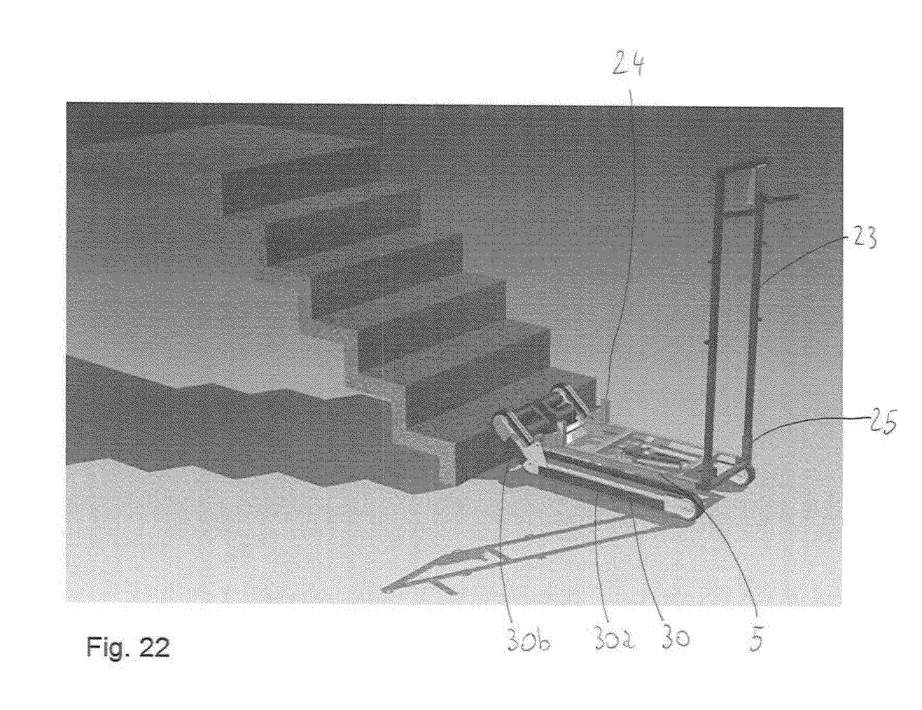

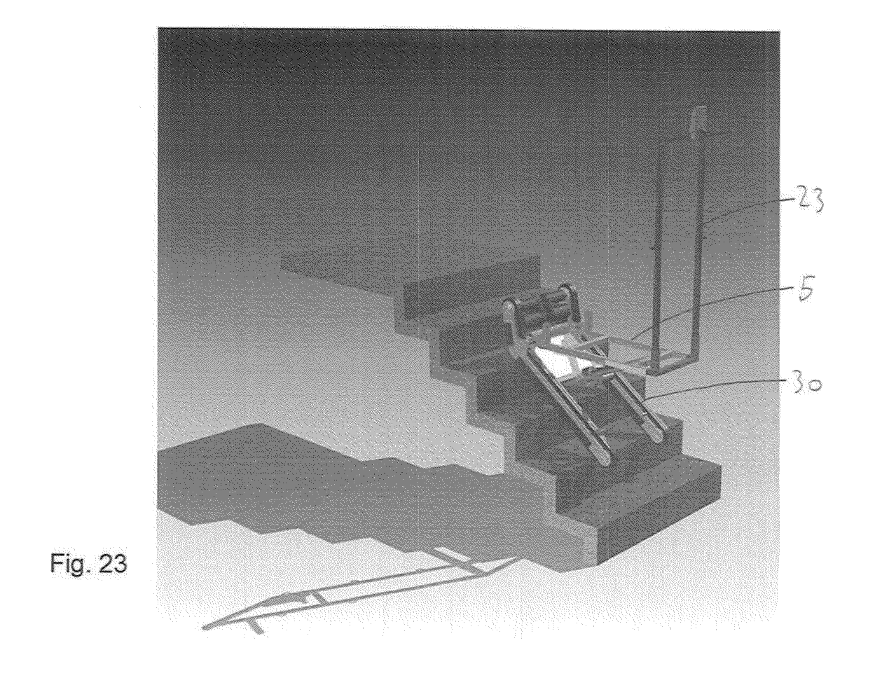

FIGS. 22 and 23 are slightly top perspective views of the trolley of FIGS. 20 and 21 during respective transportation steps for a load on a staircase;

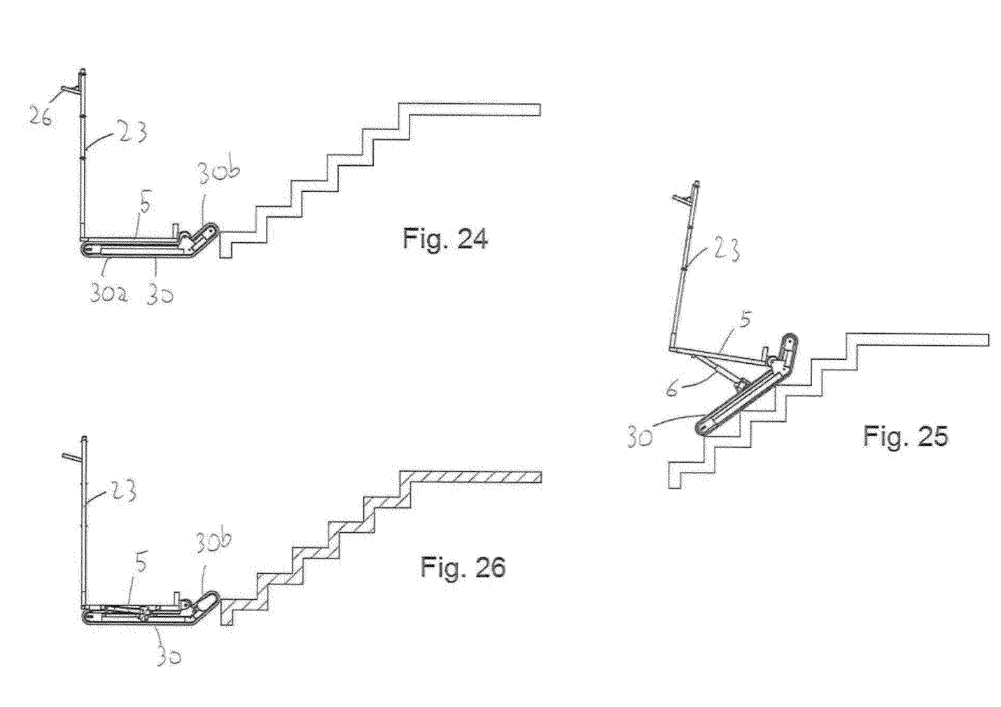

FIGS. 24 and 26 are side views of the trolley of FIGS. 22 and 23 during respective steps for transporting a load on a staircase;

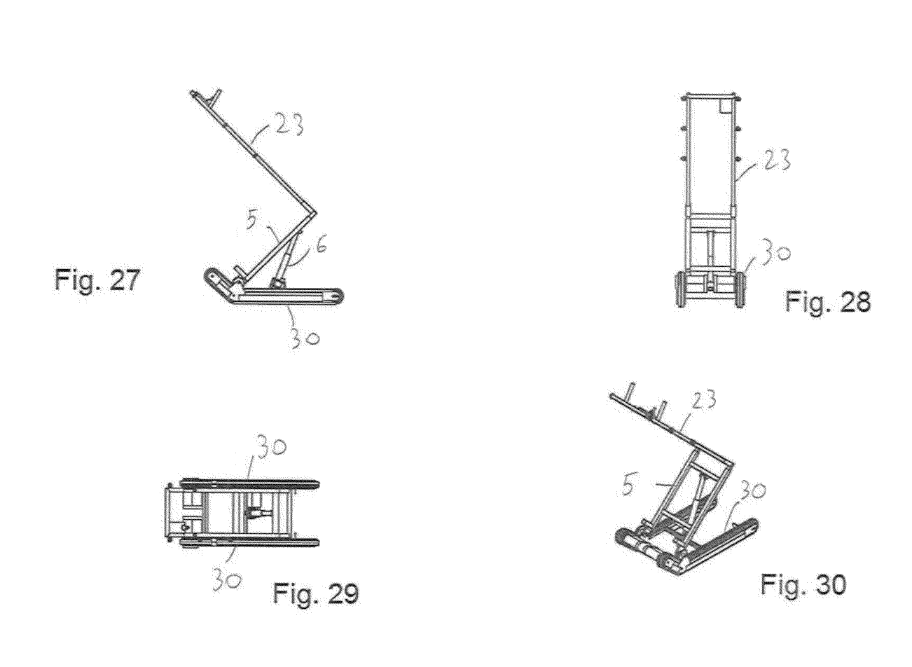

FIGS. 27 to 30 are respectively side, front, bottom and slightly top perspective views of the trolley of FIGS. 20 and 21.

In the accompanying drawings, equivalent or similar parts or components were marked with the same reference numbers.

With reference first to FIGS. 1 to 7, a trolley 1 is illustrated according to the present invention designed to transport a load on staircases, which comprises a main support frame 2 and one or more tracks 3, which are movably or rotatably mounted so as to project on the lower part from the main support frame 2 and which on the lower part define a first slide surface 4 of the trolley 1. For such purpose, preferably, the track/tracks 3 is/are sent around first pulleys or toothed wheels 12 mounted for rotation around first rotation axes (orthogonal to the sheet) and around pins or the like 19, such that each track 3 has a first section, upper in use 3a, preferably flat, a second section, lower in use 3b, preferably flat, as well as two connector curves 3c of the two sections 3a, 3b. The first slide surface 4 is defined by the lower surface (lower in use) of the lower sections 3b. Preferably, two tracks 3 are provided that are substantially parallel to and spaced from each other.

Motor means or means for actuating the track/tracks 3 are then provided, such as an electric motor or the like, not illustrated in the drawings, designed to control the rotation of the track/tracks 3, and if the trolley rests on a surface at the tracks, the advancement of the trolley 1 on the surface. Preferably, each of the two main tracks 3 can be actuated by respective motor means in a manner independent from the other main track 3. Each track 3 can then comprise tensioning rollers 18 for the tracks 3.

The main frame 2 then supports one or more load beds 5 on which the objects to be transported are placed and defining a support surface 5a directed upward in use, and preferably means are provided for tilting or for the angular movement 6 of the load bed/beds 5 with respect to the support frame 2 as well as with respect to the main track/tracks 3. The means for tilting or for the angular movement can for example comprise one or more actuators or jacks, e.g. electric, hydraulic or pneumatic jacks, which are pivoted on one side, e.g. at one end of the cylinder 6a thereof to the main frame 2 and on the other side, e.g. at one end of the stem 6b thereof to the load bed 5. The means for the angular movement 6 are designed to angularly move the load bed 5 around a substantially horizontal axis, preferably transverse to the tracks 3, between a position in which it (the load bed 5) delimits a support surface 5a substantially parallel to the first lower slide surface 4 and a position in which it defines a support surface 5a substantially tilted with respect to the first lower slide surface 4. As will be understood, the means for tilting or for the angular movement 6 of the load bed/beds 5 allow compensating for the slope of the staircase on which the load is moved (in descent or ascent), i.e. when the load is moved on the staircase, the means for the angular movement 6 allow tilting the load bed 5 with respect to the frame 2 and, if desired, placing the load bed 5 in a substantially horizontal position so as to prevent or limit as much as possible the load from slipping with respect to the load bed 5 during the ascent or descent.

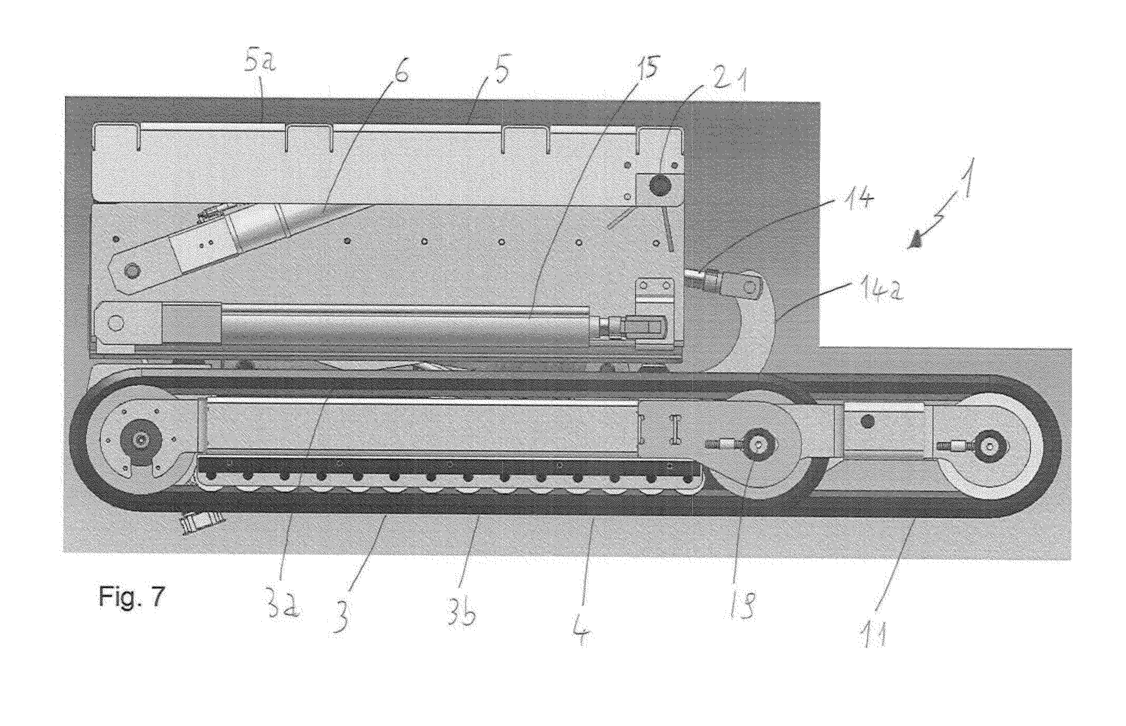

A trolley according to the present invention then preferably comprises an auxiliary frame structure 7 (see FIG. 7) which has means for supporting and sliding or rolling on a surface, e.g. wheels 8 delimiting on the lower part a second slide surface 9; lifting-lowering means 10a, 10b are also provided for the auxiliary frame structure 7 intended to move the auxiliary frame structure 7 with respect to the support frame 2.

The lifting-lowering means 10a, 10b can for example comprise one or more actuators 10a, if desired linear, e.g. electric, hydraulic or pneumatic actuators, pivoted at one end thereof to a portion of the auxiliary frame structure 7 and at the other end to the main support frame 2. The lifting-lowering means can also provide for an articulated polygon group 10b, e.g. an articulated parallelogram group, which is pivoted on one side to the auxiliary frame structure 7 and on the other side to the support frame 2.

More particularly, the auxiliary frame structure 7 comprises a base component 7a, below which the wheels 8 are pivoted, e.g. two or four wheels with horizontal rolling axis (horizontal in use). The wheels 8, if desired, can be pivoted around a horizontal axis to brackets 7b, which can be pivoted to the base component 7a around a vertical axis, such that the wheels 8 can be oriented in different running directions, or the brackets can be fixed or are fixable to the base component 7a.

The actuator 10a and the articulated parallelogram group 10b can then be pivoted to the base component 7a or to strip elements 7c projecting upward therefrom.

The lifting-lowering means 10 are designed to move the auxiliary frame structure 7 between:
an upper rest position (see FIGS. 1 to 7), in which the auxiliary frame structure 7 is situated with its support and slide or roll means 8 at a higher level than that of the first slide surface 4 and the trolley 1 is movable by means of the main track/tracks 3, and
a lower work position (see FIG. 7), in which the main support frame 2 is at a higher level than the auxiliary frame structure 7 and the trolley 1 rests on the auxiliary frame structure 7 and is movable on the slide or roll means 8.

Preferably, the second slide surface 9 is substantially parallel to the first slide surface 4.

Advantageously, when the auxiliary frame structure 7 is placed in the lower work position, the main track/tracks 3 projects/project beyond the auxiliary frame structure 7 at the front F and/or at the back R of the trolley. Still more advantageously, the auxiliary frame structure 7 is housable at an intermediate section of the main support frame 2 and when placed in the upper rest position it is completely arranged within the bulk of the main support frame 2. For such purpose, the auxiliary frame structure 7 preferably has lesser width than the distance between the tracks 3 and is movable between the main tracks 3 between the upper rest position and the lower work position, such that in the upper rest position it is housed within the bulk defined by the main tracks 3 and with slide or slip means (e.g. wheels) 8 at a level higher than the tracks.

In addition to one or more main tracks 3 defining the first slide surface 4, an auxiliary track 11 can be provided for one or each main track 3, such auxiliary track 11 placed on the front F or on the back R of the respective main track 3 and is tilted or tiltable with respect thereto. More particularly, as stated above, the main track/tracks 3 is/are mounted or sent around first pulleys or toothed wheels 12, preferably two, rotatably mounted around first rotation axes (orthogonal to the drawings), whereas each auxiliary track 11 is sent around second pulleys or toothed wheels 13, preferably two, rotatably mounted with respect to second rotation axes (also orthogonal to the sheet according to the illustrated embodiment), with the first rotation axes of a main track 3 being substantially parallel to the second rotation axes of a respective auxiliary track 11, such that an auxiliary track 11 is extended starting from the front F or from the back R of a respective main track 3. If desired, a toothed wheel 12 of a main track 3 and a toothed wheel 13 of an auxiliary track are mounted around a same axis or rotation pin 19.

For such purpose, the trolley can also be provided with one or more actuators or the like 14 designed to angularly move the auxiliary track/tracks 11 relative to the main track 3. The actuators 14 are intended to move the auxiliary track/tracks 11 angularly around a transverse axis of the trolley.

The actuator/actuators 14 can have one component pivoted to the main frame 2 or to another component of the trolley and a second component pivoted, by means of a lever 14a or the like, to one or more auxiliary tracks 11.

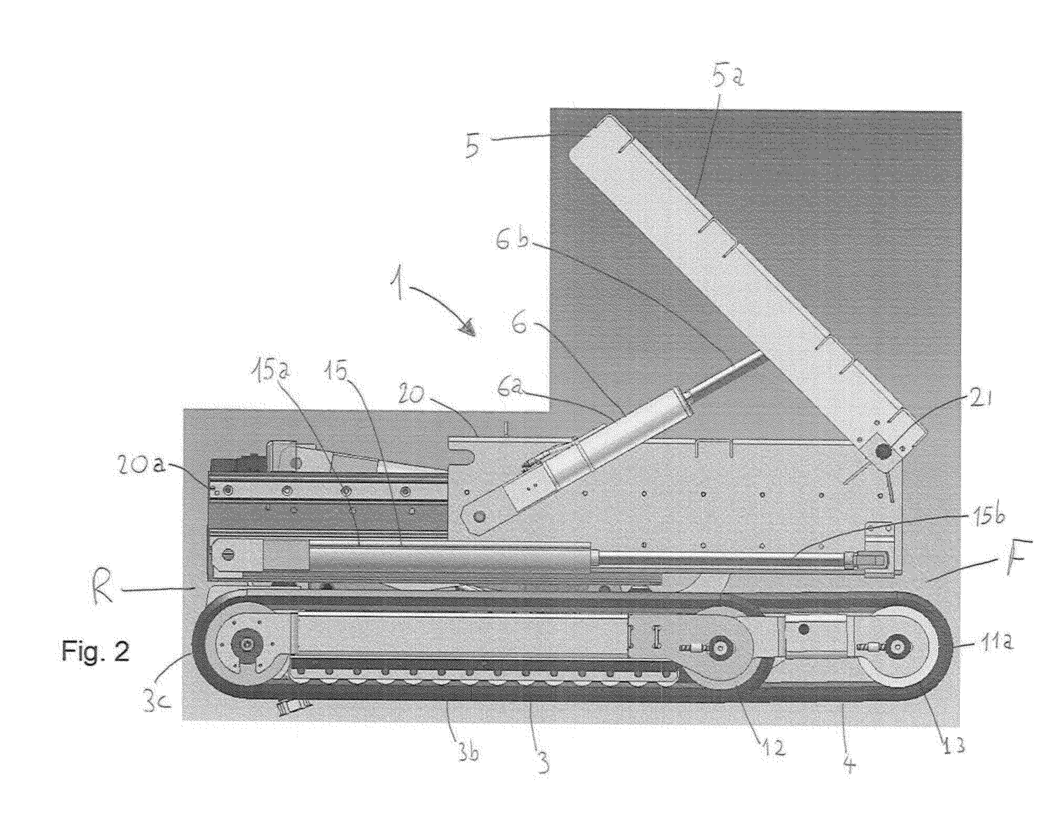

Each auxiliary track 11 can then be angularly moved around a rotation axis of a respective toothed wheel or pulley 13, in one direction or in the other with respect to the respective main track 3, e.g. between a position in which it has free end 11a higher than the respective main track 3 (see FIG. 2) and a position in which it has free end 11a lower than the respective main auxiliary track (see FIG. 2). In such case, naturally, in an intermediate position the auxiliary track 11 would be substantially aligned with the respective main track 3. If desired, the auxiliary track/tracks 11 can also be moved between a position of substantial alignment with a respective main track 3 and a position with free end 11a higher or lower than the respective main track 3.

As will be understood, by placing one or more auxiliary tracks 11 with free end 11a higher than the respective main track 3, it is possible (during the ascent of a staircase with a trolley according to the present invention) to engage the first step of a staircase by means of the free end of the auxiliary track/tracks 11, while the trolley is still on the landing or at the bottom of the staircase. By placing instead one or more auxiliary tracks 11 with free end 11a lower than the respective main track 3, it is possible (during the descent of a staircase with a trolley according to the present invention) to engage a lower step or the landing at the bottom of a staircase by means of the free end of the auxiliary track/tracks 11, while the trolley rests on one or more upper steps, so as to prevent, as will be understood, the oscillating of the trolley during the descent.

Preferably, each auxiliary track 11 has lesser extension than the respective main track 3.

Preferably, the auxiliary track 11 are actuated by means of respective second motor means.

Advantageously, the trolley 1 is also provided with means 15 for actuating or moving the load bed 5 onto the support frame 2 parallel to the main axis (front F-back R direction) of the main track/tracks 3, such actuation or movement means 15 set to translate the load bed 5 onto the support frame 2. The actuation means can comprise an actuator, e.g. linear actuator 15, mounted with position substantially parallel to the main dimension of the main tracks 3, with cylinder 15a pivoted to the frame 2 and stem 15b pivoted to the load bed 5. In such case, the trolley 1 can comprise a small frame or movable frame 20 slidably mounted, preferably at a higher level than the main tracks 3, on the support frame 2 and on which the load bed 5 is pivoted at 21. In such case, the actuator 15 is pivoted on one side to the support frame 2 and on the other side to the small movable frame 20, while the tilt or angular movement means 6 are pivoted on one side, e.g. at one end of a cylinder 6a thereof to the small movable frame 20 and on the other side, e.g. at one end of the stem 6b thereof to the load bed 5.

Preferably, the movable frame 20 is slidably mounted on guide components 20a of the main frame 2. More particularly the movable frame 20 is movable in the direction from the back R to the front F of the trolley 1 and in the direction parallel to the main longitudinal direction of the tracks 3.

If desired, the movable frame 20 is movable between a retracted position, in which the movable frame 20 is just above the main track/tracks 3 and occupies a longitudinal bulk equal to or less than the main track/tracks 3 and an extended position. More particularly, when the main track/tracks 3 and the auxiliary track/tracks 11 are placed in a substantially aligned position, the movable frame 20 in extended position is partly above the main track/tracks 3 and partly above the auxiliary track/tracks 11. This allows suitably centering the barycenter of the load over the entire length of the tracks so as to obtain the maximum stability during the transportation on staircases, since the auxiliary tracks actually constitute an extension of the main tracks, and particularly when the main tracks and the auxiliary tracks are aligned, the total length of the aligned tracks is naturally greater than the length of the single main tracks and by moving the movable frame 20 with the load bed 5 it is possible to center the load as a function of the alignment (longitudinal extension of the main tracks+greater auxiliary tracks) or non-alignment (longitudinal extension of the main tracks+lesser auxiliary tracks) of the main and auxiliary tracks.

With a trolley according to the present invention, if it is required to transport a load up a staircase, the trolley would be brought to the staircase with the auxiliary frame structure 7 in lower work position (see FIG. 7) and the main tracks at the level of the first or second step. Then, the trolley would be made to slide on the support and slide or roll means, which in particular comprise wheels 8 that can be oriented in different running directions and the main tracks or a front end thereof would be brought on top of the first or second step. The movement would then be commanded of the auxiliary frame structure 7 in upper rest position, so as to cause the lifting of the frame structure and the support of the trolley, in particular of the main tracks 3 at the first or if desired second step of the staircase. At this point, upward transportation of the trolley on the staircase could continue on the main tracks 3, by means of actuation thereof by the respective motor means, if desired with the aid of the auxiliary tracks 11, which if suitably tilted with free end at a level higher than the main tracks would be able to engage a subsequent or higher step and facilitate the lifting of the trolley up to the level of such subsequent step.

Naturally, during the ascent, it is possible to suitably move the load with respect to the main frame 2 and to the tracks 3, e.g. due to angular movement means 6 or to actuator means 15.

With regard instead to the descent steps, a trolley according to the present invention can be driven in the same manner described above, but in reverse sequence.

With reference now to FIGS. 8 to 30, a second trolley embodiment is illustrated according to the present invention, similar to the above-described trolley, but in which one or more main tracks 30 comprise a main section 30a which defines the first slide surface 4 and at least one secondary section 30b tilted or tiltable with respect to the main section 30a and placed at the front F or back R of the trolley. More particularly, each track 30 is sent around two toothed wheels or chains 12 and between the main section 30a and the secondary section 30b a transmission component 22 is provided, if desired adjustable, intended to deflect or tilt the secondary section 30b with respect to the main section 30a.

The trolley illustrated in the FIGS. 8 to 30 does not have to be provided with auxiliary frame structure 7 and with lifting-lowering means 10a, 10b, even though, as will be understood, it could be provided with such components. In such case, the ascent and descent on the staircase would be assigned to the main tracks 30 or to the main tracks 3 with auxiliary tracks 11.

The trolley is then preferably provided with a handle 23, as well as with a first engagement portion 24 for the handle 23 placed at the front F of the trolley 1, and a second engagement portion 25 for the handle or grip 23 placed at the back R of the trolley 1. The engagement portions 24 and 25 comprise one or more pairs of tubular components with opening directed upward in use; a respective stem or rod of the handle 23 is insertable in such tubular components, such stem supporting grip elements 26 at the top that can be grasped by the user. Naturally, control means can be provided on the handle, such as a push-button panel of the trolley.

Due to such expedient, the operator can decide to maneuver the trolley by means of a handle placed on the front or on the back thereof.

The tubular components 24 and 25 can be projected upward from the support frame 2 or from the load bed 5. More particularly, the load bed 5 can comprise a telescopic structure, with tubular elements in which rod-like elements can be inserted or disconnected, so to be able to lengthen-shorten the support surface 5a.

As will then be understood, the tracks 30 could be mounted on the trolley of FIGS. 1 to 7, just like the handle 23 with engagement portions 24 and 25 could be provided on such trolley.

A trolley according to the present invention can then provide for means (not illustrated in the drawings) for rotating the load bed 5 around an axis substantially vertical or orthogonal to the load bed 5.

For the control of the movements and the position of the components of a trolley according to the present invention, the trolley can be provided with a program control unit (not illustrated in the drawings) so as to automate the ascent or descent of the trolley on a staircase. Furthermore, a trolley according to the present invention can be controlled by means of a remote control or another remote control system.

As will be understood, due to a trolley according to the present invention it is possible to safety transport a load up or down a staircase of any size or shape, whether helical or straight.

1. A trolley for the transportation of a load on staircases having a main support frame, at least one main track mounted for rotation thereby projecting below said main support frame in order to define a first lower slide surface for the trolley, motor means or actuation means for said at least one main track, and at least one load bed supported by said main support frame, wherein said trolley comprising:
at least one auxiliary frame structure provided with support and slide or roll means delimiting a second slide surface on the lower part, and
lifting-lowering means for said at least one auxiliary frame structure designed to move said at least one auxiliary frame structure with respect to said main support frame between an upper rest position, in which said at least one auxiliary frame structure is located with its support and slide or roll means at a higher level than that of said first slide surface and said trolley is movable by said at least one main track, and a lower work position, in which said main support frame is at a level higher than said at least one auxiliary frame structure and said trolley rests on said at least one auxiliary frame structure and is movable on said slide or roll means; said auxiliary frame structure is housable at an intermediate section of said main support frame and when placed in said upper rest position it is arranged completely within the bulk of said main support frame.

2. A trolley according to claim 1, wherein said at least one main track projects beyond said auxiliary frame structure at the front and/or back of said trolley when said auxiliary frame structure is placed in said lower work position.

3. A trolley according to claim 1, wherein said lifting-lowering means comprise at least one linear actuator pivoted at one end thereof to a portion of said auxiliary frame structure and at the other end thereof to said main support frame.

4. A trolley according to claim 3, wherein said lifting-lowering means comprise an articulated polygon group pivoted on one side to said auxiliary frame structure and on the other side to said main support frame.

5. A trolley according to claim 1, wherein said support and slide or roll means comprise wheels that can be oriented in different running directions.

6. A trolley according to claim 1, wherein it comprises means for the angular movement of said at least one load bed with respect to said main support frame.

7. A trolley for the transportation of a load on staircases having a main support frame, at least one main track rotatably mounted so as to project below said main support frame in order to define a first lower slide surface for the trolley, actuation means for said at least one main track, and at least one load bed supported by said main support frame, wherein it comprises means for the angular movement of said at least one load bed with respect to said main support frame, and at least one auxiliary track placed on the front or on the back of said at least one main track and tilted or tiltable with respect to said at least one main track, said at least one main track being mounted on first pulleys or toothed wheels for rotation on first rotation axes, whereas said at least one auxiliary track is sent around second pulleys or toothed wheels mounted for rotation on second rotation axes, said first rotation axes being substantially parallel or coinciding with said second rotation axes, or at least one secondary section of said at least one main track tilted or tiltable with respect to a main section of said at least one main track, said at least one secondary section being placed at the front or back of said trolley.

8. A trolley according to claim 7, wherein at least one auxiliary track is placed on the front or on the back of said at least one main track and tilted or tiltable with respect to said at least one main track, said at least one main track being mounted on first pulleys or toothed wheels for rotation on first rotation axes, whereas said at least one auxiliary track is sent around second pulleys or toothed wheels mounted for rotation around second rotation axes, said first rotation axes being substantially parallel or coinciding with said second rotation axes.

9. A trolley according to claim 8, wherein it further comprises at least one linear actuator designed to angularly move said at least one auxiliary track with respect to said at least one main track.

10. A trolley according to claim 1, wherein said at least one main track comprises at least one main section defining said first slide surface and at least one secondary section tilted with respect to said main section and placed at the front or back of said trolley.

11. A trolley according to claim 7, wherein said at least one main track is sent around two pulleys or toothed wheels and between said main section and said secondary section a transmission component is provided that is designed to deflect or tilt the secondary section with respect to the main section.

12. A trolley according to claim 7, wherein means for the angular movement are designed to angularly move said at least one load bed around a substantially horizontal axis between a position in which it delimits a support surface substantially parallel to said first lower slide surface and a position in which it defines support surface substantially tilted with respect to said first lower slide surface.

13. A trolley according to claim 1, wherein it further comprises actuator means set to translate said at least one load bed onto said support frame.

14. A trolley according to claim 13, wherein it further comprises a movable frame slidably mounted on said support frame and pivoted to said load bed, said actuator means being designed to translate comprising a linear actuator pivoted on one side to said support frame and on the other side to said movable frame.

15. A trolley according to claim 6, wherein said means for the angular movement are pivoted on one side to said movable frame and on the other side to said load bed.

16. A trolley according to claim 1, wherein said at least one main track comprises at least two tracks substantially parallel to and spaced from each other, and each main track can be actuated by a respective motor means in a manner independent from the other main track.

17. A trolley according to claim 1, wherein it further comprises a handle, as well as a first engagement portion for said handle at the front of said trolley, and a second engagement portion for said handle placed at the back of said trolley, such that said handle can be placed on the front or on the back of the trolley.
